(19) United States
(12) Patent Application Publication
(10) Pub. No.: US 2023/0324282 A1
(43) Pub. Date: Oct. 12, 2023

(54) OPTICAL MEASURING CELL

(71) Applicant: CS Instruments GmbH & Co. KG, Harrislee (DE)

(72) Inventors: Ralph KONDZIELLA, Villingen-Schwenningen (DE); Pascal BIPPUS, Brigachtal (DE)

(73) Assignee: CS Instruments GmbH & Co. KG, Harrislee (DE)

(21) Appl. No.: 18/131,572

(22) Filed: Apr. 6, 2023

(30) Foreign Application Priority Data
Apr. 6, 2022 (DE) 10 2022 108 236.9

(51) Int. Cl. G01N 21/03; G01N 21/31

(52) U.S. Cl. CPC G01N 21/031; G01N 21/3103

(57) ABSTRACT

An optical measuring cell designed and provided for the absorption spectroscopic determination of at least one chemical and/or physical parameter of a fluid. A light beam for the absorption spectroscopic analysis is coupled into an interior of a housing, together with the fluid to be analyzed, via a coupling-in element connected to the housing such that the coupled-in light beam runs in the interior of the housing in parallel to the optical main axis of the measuring cell or the housing. A coupling-out element connected to the housing couples a light beam striking the coupling-out element out of the housing in order to supply the light beam, after multiple passes through the interior, to a detector for the absorption spectroscopic determination of a chemical and/or physical parameter of the irradiated fluid.

This nonprovisional application claims priority under 35 U.S.C. § 119(a) to German Patent Application No. 10 2022 108 236.9, which was filed in Germany on Apr. 6, 2022, and which is herein incorporated by reference.

### BACKGROUND OF THE INVENTION

### Field of the Invention

The invention relates to an optical measuring cell for the absorption spectroscopic determination of at least one chemical and/or physical parameter of a fluid.

### Description of the Background Art

Optical measuring cells of this type are frequently used in spectroscopy to observe components of low concentration. To improve the detection sensitivity of this measuring cell, the total optical path length traveled by a small, constant sample volume is selected to be as long as possible, since a longer path length results in a higher detection sensitivity. To achieve this, the optical path length is deflected by optical reflecting elements in such a way that the measuring cell is passed through multiple times; these are referred to as multipass measuring cells. The output of the cell is the input of an optical detector, which detects specific changes in the properties of the beam due to the pass through the measuring cell, so that the desired statements on the components to be analyzed may be derived therefrom. Refer to the Wikipedia article “Multipass spectroscopic absorption cells”. (https://en.wikipedia.org/wiki/Multipass_spectroscopic_absorption_cells).

Two conventional multipass cells are the White cell and the Herriott cell. They are commonly used in trace gas sensor technology as well as in environmental and industrial processes.

The White cell uses three spherical concave mirrors having the same radius of curvature, the two smaller concave mirrors being spaced apart by a gap, and the other larger mirror being situated opposite thereto. A light beam is cast at an angle onto one of the concave mirrors from the outside and subsequently reflected by the concave mirrors to each other multiple times until the light beam exits the cell at an angle and strikes the detector.

The Herriott cell is made up of two opposing spherical mirrors. A hole is typically machined into one of the mirrors, so that the input and output beams may enter and exit the cavity at an angle. Alternatively, the beam may exit through a hole in the opposite mirror. In this way, the Herriott cell may support multiple light sources, in that it provides multiple entry and exit holes in each of the mirrors. A comparable Herriott cell is also known from the German unexamined patent application DE 103 08 883 A1.

Another optical measuring cell is known from DE 41 24 545 C2, which corresponds to U.S. Pat. No. 5,125,742, which completely mirrors the cylindrical measuring cell internally to generate a particularly long light path, couples the measuring beam into the measuring cell at an angle through a gap and thereby reflects it multiple times onto the inside, and allows it to exit again through the gap and supplies it to the detector.

Various conventional multipass cells are known from US 2016/0202175 A1; among other things, a White cell and a Herriott cell, as well as other multipass cells are described.

Multipass cells are further known from US patent application US 2021/0199572 A1, in which two prisms are arranged symmetrically in the measuring chamber in such a way that they are slightly offset from each other, and the laser beam enters the measuring cell and exits the measuring cell after it has made multiple passes through the total reflection of the prisms. The passes run between the prisms essentially in parallel to each other. In particular, since the prism are arranged slightly offset from each other at a symmetrical position, an internal total reflection pass is elongated in such a way that this is advantageous for measuring fine dust precursors having a low concentration. To compensate for temperature, it is proposed to keep a heating system and a circulating medium within the desired temperature range with the aid thereof. This multipass measuring cell has proven to be extremely complex in its construction and very sensitive with respect to external influences, such as temperature changes or mechanical shock.

These measuring cells have proven to be not very robust, for example, with respect to thermal changes or vibrations.

### SUMMARY OF THE INVENTION

It is therefore an object of the invention to specify an optical measuring cell which is improved over the prior art for the absorption spectroscopic determination of at least one chemical and/or physical parameter of a fluid.

The object is achieved according to the invention by an optical measuring cell that is designed and provided for the absorption spectroscopic determination of at least one chemical and/or physical parameter of a fluid. It includes a housing having a tube, cover, and base, into which the fluid to be analyzed is introduced.

A light beam for the absorption spectroscopic analysis is coupled into the interior of the housing, together with the fluid to be analyzed, via a coupling-in element connected to the housing, in such a way that the coupled-in light beam runs in the interior of the housing in parallel to the optical main axis of the measuring cell or the housing.

The cover and the base are connected to deflecting elements for the light beam in the housing, which reflect the light beam, incident upon the deflecting element and running in parallel to the optical main axis of the measuring cell, or the housing into the interior of the housing in parallel to the optical main axis of the measuring cell or the housing, laterally offset with respect to the incident light beam.

A coupling-out element connected to the housing is further provided, which couples out of the housing a light beam striking the coupling-out element from the interior of the housing for the purpose of supplying the coupled-out light beam to a detector, after multiple passes through the interior, for the absorption spectroscopic determination of a chemical and/or physical parameter of the irradiated fluid.

The fluid-filled interior of the housing is irradiated multiple times. Multiple times means a number in the range of some 10 times or, in the case of relatively high absorption coefficients of a component to be measured in a fluid, for example moisture in air, in the range of 10 times, in particular 4 to 8 times. An irradiation of the measuring cell of more than 100 times is not desirable since the irradiation of the measuring cell according to the invention is very targeted and specific and is therefore sufficient.

With the aid of this optical measuring cell according to the invention, it is possible to determine chemical and/or physical parameters of a fluid, for example, the concentration of a gas component in a gas mixture, the moisture in an, in particular, gaseous fluid, the temperature or also the dew point of the fluid, and to facilitate this in a highly precise and robust manner, since is supported to a particular extent by the structure of the optical measuring cell having the specially designed beam path in the housing with the multiple passing through the interior of the housing and thus through the fluid to be analyzed.

Not only coherent laser beams, but also, in particular, light beams from light sources which do not emit monochrome or even not very focused or collimated light, have proven to be successful as light beams. The use of light beams having a greater coherence length increases the risk that the light beam becomes overlaid in a disturbing and interfering manner during the multiple crossing of the measuring cell and thereby damages the measurement result, which is less the case when using non-monochrome and/or not very focused and/or collimated light and thereby may lead to a more reliable measurement result.

It has also been shown that small deviations in the direction of the light beams when crossing the measuring cell in parallel to the optical main axis are acceptable and nevertheless permit a sufficiently reliable measurement result.

The optical measuring cell can have a cover and/or a base, which is provided with multiple roof prisms arranged on the sides of a regular 2n-gon, the roof prisms being arranged in such a way that each second side of the regular 2n-gon is provided with a roof prism so that its base surface preferably cover the entire side of the 2n-gon. In particular, each vertex of the 2n-gon is covered by the basic surface of a roof prism in such a way that a side surface of the roof prism is arranged above the vertex.

This arrangement ensures that an incident light beam from the interior of the housing in parallel to the optical main axis of the measuring cell or the housing may be incident via the base surface of the roof prism, refracted on the one side surface of the roof prism, passed on perpendicularly to the optical main axis in the direction of the other side surfaces of the roof prism and deflected thereby back into the interior of the housing in parallel to the optical main axis, and guided thereby, laterally offset with respect to the incident beam and thus guided in a defined manner to the opposite cover or base of the housing with the aid of the assigned deflecting element. This design of the cover or the base makes it possible to use different light beams or measuring operations in parallel to each other and to thereby expand the functionality of the optical measuring cell. It is furthermore possible, with the aid of a corresponding design of the opposite base or cover having corresponding deflecting elements, for example identical deflecting elements rotationally offset around a vertex of the 2n-gon, to pass a light beam through all room prisms one after the other and to thereby pass through the interior 2n times in a defined manner and to thereby achieve a particular precision and robustness of the optical measuring cell.

It has proven to be particularly successful to refine the device according to the invention in such a way that deflecting elements connected to the cover and the base are selected from roof prisms, plano-convex lenses, concave mirrors, conical mirrors, conical lenses, retro-reflector optical units. Different combinations of the aforementioned deflecting elements have proven to be particularly successful. The arrangement, the geometry, and the materials of the deflecting elements are selected in such a way that incident light beams from the interior of the housing in parallel to the optical main axis are emitted into the interior in an offset manner and in parallel to the optical main axis.

In particular, the use of roof prisms, to which the particularly advantageous Dove prisms also belong, is particularly suitable, since the desired back reflection with offset is made possible in an easy and efficient as well as reliable manner due to the at least two of its oblique side surfaces of the roof prism. For this purpose, the roof prisms are designed with their base surfaces in such a way and connected to the cover and/or to the base, so that incident light from the interior of the housing enters perpendicularly through the base surface and, due to the direction of incidence of the incident light beam in parallel to the optical main axis of the reflected, offset light beam, is radiated into the interior of the housing, and thus in the direction of the opposite base or cover, again in parallel to the optical main axis. These have proven to be extremely flexible with regard to the adaptation to the desired geometry of the optical measuring cell and, in addition, as highly robust with regard to dimensional inaccuracies in the design of the optical measuring cell.

Correspondingly, plano-convex lenses or concave mirrors have proven to be successful, which reflect into the interior the light beams incident in parallel to the optical axis from the interior in an offset manner and in parallel to the optical main axis. Each planar side of the plano-convex lenses is assigned to the interior of the housing in such a way that the incident light beams may enter the plano-convex lenses efficiently and with as little attenuation as possible.

The concave mirrors can have a simple structure, which, however, has an undefined, position-dependent light path in the concave mirror between entering the concave mirror and reaching the reflection surface and leaving the concave mirror, and is thus connected to the measuring cell and automatically has an influence on the measurement result. Due to the different position-dependent light paths in the concave mirror, the total light path may no longer be sufficiently precisely determined. This has a particularly disturbing effect at low absorption coefficients of a component to be measured in a fluid and, in particular, in the case of a higher number of crossings in the measuring cell.

The plano-convex lenses, however, exhibit defined light paths, which improves the meaningfulness of the measurement results.

A further particularly preferred design of the deflecting element exhibits the structure of a retro-reflector optical unit, which is known, for example, from the reflectors used in motor vehicle traffic or from distance measurement using lasers. The retro-reflector optical units have a very simple, effective, and robust construction. Even though these deflecting elements designed as retro-reflectors exhibit edges in the region of the incident or emergent light beams, and the risk is thereby increased that different light paths are generated by the edges and the measurement results are worsened thereby, these deflecting elements have proven to be successful for a measuring cell of this type, due to their simple and effective and robust construction.

It has proven to be particularly advantageous to select the diameter of the 2n-gon to be much smaller than the diameter of the lens and thereby to very reliably and confidently define the arrangement of the roof prisms, which has a positive effect on the defined light path in the measuring cell and thus on the measurement result. It has furthermore proven to be particularly successful to select the center point of the 2n-gon on the optical main axis and thus preferably on the axis of symmetry of the lens, so that the roof prisms are arranged precisely around the optical main axis and thereby facilitate a highly defined light path.

An example of the invention provides an optical measuring cell, in which the cover is connected to n deflecting elements designed as roof prisms in such a way that they are arranged on each second side of a regular 2n-gon, and the base is connected to a deflecting element designed as a concave mirror or as a plano-convex lens, in particular having a parabolic cross-section. The selection of a parabolic cross-section, in particular, ensures that the offset takes place in such a way that the incident light beam in parallel to the optical main axis is deflected perpendicularly to the optical main axis via the focal point on the other size of the deflecting element, from where it is deflected into the interior of the housing, again in parallel to the optical main axis of the optical measuring cell, and thus in the direction of the cover with the roof prisms. Due to this arrangement of the specific cover and base, it is possible with the aid of the particular deflecting elements, for a light beam to strike the base from a vertex of the 2n-gon and thus from a roof prism, there to be reflected to the opposite side, and again in the direction of the cover in parallel to the optical main axis, to enter the interior therethrough, like the incident light beam, until it strikes the opposite vertex of the 2n-gon and is laterally reflected via the room prism situated there along the side covered by the roof prism again in the direction of the interior and thus in the direction of the opposite base in parallel to the optical main axis. This process repeats until the light has passed through all vertex points and all prism, and a coupling-out takes place with the aid of a coupling-out element. A highly robust and not very sensitive arrangement is created thereby, which demonstrates a high degree of tolerance for a rotation of the base with respect to the cover with the assigned optical elements. A small number n of roof prisms is preferably selected, between 3 and 5, in particular equal to 3. These numbers permit a particularly advantageous compromise between technical and mechanical or optical complexity and precision and robustness of the optical measuring cell for an absorption spectroscopic determination of properties of a fluid.

An example of the invention provides an optical measuring cell, in which at least one deflecting element is designed in such a way that the incident light beam and the reflected light beam run axisymmetrically to the optical main axis of the measuring cell or the housing and thus the optical measuring cell. This makes it possible to reduce the influence of the rotational orientation of this deflecting element on the quality of the measurement results and to thereby improve the robustness of the optical measuring cell. It has proven to be particularly successful to refine the device according to the invention in such a way that the coupling-in element and/or the coupling-out element is/are connected to the cover or base. Due to this defined, static connection of the coupling-in element or the coupling-out element to the cover or the base, it is possible to ensure an extremely reliable and secure coupling in of the light beam into the optical measuring cell or into the interior of the housing of the optical measuring cell, which is also not very sensitive to shocks.

It has also proven to be successful to refine the optical measuring cell according to the invention in such a way that the coupling-in element and/or the coupling-out element may include an optical element, in particular a prism, connected to the roof prism. The connection preferably takes place with the aid of an optical neutral adhesive, which connects the optical element for the coupling in or out, in particular the prism, to the roof prism in such a way that at least essential portions of the light beam coupled into the roof prism are coupled out or in via the side wall of the roof prism and are guided thereby out of the optical measuring cell to a detector for detecting the absorption or in the direction of the interior of the housing of the optical measuring cell.

A common optical element can forms both the coupling-in element and the coupling-out element. This may take place, for example, by the preferred design of the optical element as a triangular prism or roof prism, whose base surface is mounted on the side surface of the deflecting element designed as a roof prism. This makes it possible to use the same side of the roof prism as the coupling-in and coupling-out side of the light beam into or out of the measuring cell, which permits a simple and compact construction of the measuring cell in the region of the coupling-in element or coupling-out element. This design of the optical element proves to be particularly efficient and robust and also to be particularly maintenance-friendly.

A further example of the invention provides an arrangement of the housing, including a tube, cover, and base, as well as the deflecting elements, which are formed rotationally symmetrically to the optical main axis of the measuring cell or the housing and thus the optical measuring cell. This rotational symmetry is designed in such a way that the symmetry around arbitrary angles is given as well as around defined angles, for example in a design including three roof prisms arranged in the sides of a regular hexagon. In this case, a hexavalent rotational symmetry is given, and thus a rotational symmetry around a defined angle of 60°. Due to this type of measuring cell design, different orientations of the optical measuring cell may be implemented, which opens up different installation possibilities and thus permit more versatile options for use.

An example of the invention provides an optical measuring cell, in which the cover as well as the base are each assigned an additional plano-convex lens, which is assigned to the interior of the housing with its convex side and deflects the light beams incident via the planar side in parallel to the optical main axis in a focused manner in the direction of the opposite base or cover. The incident light beams running in parallel to the optical main axis are focused by the additional plano-convex lenses in such a way that they are focused in a focal point in the interior of the housing and, after passing through this focal point, move apart again and strike the opposite cover or base. These two plano-convex lenses on the base or on the cover are preferably selected in such a way that the sum of their focal lengths is selected so as to be equal to their working distance or are preferably provided with an identical design, so that a corresponding symmetrical beam path having a common focal point occurs in the tube.

The plano-convex lens(es) may be fixedly connected with their planar side to the deflecting elements, for example, with the aid of an adhesive, which exhibits the same refractive index as the plano-convex lens and thereby behaves in an optically neutral manner toward the bare lens. The use of an adhesive of this type establishes a highly robust connection, which significantly reduces the sensitivity of the optical measuring cell toward shocks and vibrations. In addition, a cylindrical lens may be glued between the deflecting element(s) and the plano-convex lenses connected thereto, and the distance between the reflecting elements and the plano-convex lenses may be introduced, for example, to increase the mechanical stiffness. Due to this refinement having the two plano-convex lenses, it is furthermore possible to reduce the influence of contaminants on the surface of the optical elements, since the light beam disturbed by the contaminant is guided out of the actual beam path by the oblique surface at the entry point, so that this scattered light is unable to be overlaid with the light beam and interfere therewith. Undesirable phase shifts or undesirable radiation components are significantly reduced thereby, and the quality of the light beam is improved thereby, which has a direct effect on the quality of the measuring signal.

The focusing effect of the plano-convex lenses on the base and on the cover can be selected in such a way that the latter bundle the light beams deflected in the direction of the interior in a focal point, and the properties of the fluid may be particularly reliably determined in the region of the focal point or the focal points, and negative, interfering effects of the interior may be reduced, particularly in the region of the tube, where, in particular, external temperature effects or turbulent flow effects of the fluid occur, and the quality of the measurement result may be improved thereby.

It has proven to be particularly successful to refine the optical measuring cell according to the invention in such a way that both plano-convex lenses exhibit a focal length f, which is equal to half the length of the housing, i.e., half the working distance between the plano-convex lenses and thus typically between the deflecting elements of the cover and the base. The reflected light beams running in parallel to the optical main axis are focused by this refinement in such a way that a common focal point is formed in the center between the plano-convex lenses, and the light beams are conducted thereby from one side to the other side, more or less diagonally through the interior of the housing. The optical path length of the light beams is additionally elongated thereby between the cover and the base, and the precision of the optical measuring cell is improved thereby. Moreover, the sequence of the irradiated roof prisms is changed by this design, which does not exhibit any negative influence on the measurement result. In this design, it is furthermore possible that the coupling in and out of the light beam into the optical measuring cell via the associated elements is possible on the same side surface of the roof prism, and the construction is simplified thereby, and the robustness of the optical measuring cell is increased.

An example of the invention also provides a tube, whose surface facing the interior is at least partially, in particular completely, designed as the surface absorbing and/or not reflecting the laser light. This makes it possible to remove scattered light which is scattered out of the actual light beam on the desired optical path through the interior of the housing to a great extent and thereby to improve the signal-to-noise ratio and thus the quality of the measurement result of the optical measuring cell.

It has also been proven to be particularly successful to refine the optical measuring cell according to the invention in such a way that the housing is designed to be gas-tight and for a gaseous fluid as the substance to be measured. The gas-tight housing is preferably also designed to be pressure-tight. In addition to the possibility for analyzing a transparent liquid with the aid of the optical measuring cell, different chemical and/or physical parameters of the gas may also be particularly advantageously determined reliably with the aid of this refinement. This includes, for example, determining the concentration of a gas component in a gas mixture, the moisture in a gas, in particular the water content in compressed air, the temperature or also the dew point of a gas, this being possible in a very precise and robust manner by means of this refinement.

To design the range of applications of the optical measuring cell in a variety of ways, it has proven to be particularly successful to refine the optical measuring cell according to the invention in such a way that a semiconductor light source, in particular an LED light source for generating the light beam, or a laser for generating the light beam designed as a laser beam, is assigned to the optical measuring cell. The laser is preferably designed as a tunable laser. This semiconductor light source, in particular the tunable laser, is preferably connected in a mechanically fixed and thus statically defined manner to the coupling-in element and thus, in particular, to the cover of the housing, so that this refinement has also proved to be especially robust, in particular, with respect to vibrations or thermal expansions.

It has proven to be particularly successful to refine the optical measuring cell according to the invention in such a way that at least one optical sensor for detecting the light intensity is assigned to the optical measuring cell, at least one optical sensor being combined with a deflecting element or with the coupling-in element or with the coupling-out element into a single structural unit, and/or the light source assigned to the optical measuring cell being combined with the coupling-in element into a single structural unit or jointly into a single common structural unit. Due to this grouping as one or multiple structural unit(s), it is possible to increase the resistance to thermal expansions or vibrations or shocks and to thereby further improve the robustness of the optical measuring cell. The optical sensor(s) is/are connected to the optical element(s) of the measuring cell, preferably directly without an air gap, so that the entire light path is formed without interfering air or surroundings of the measuring cell on the light path between the sensor(s) through the measuring cell. This is achieved in that the optical sensor(s) is/are connected directly, in particular by gluing, to a deflecting element or to the coupling-out element, which may also form the coupling-in element, without an air gap. It is also possible to generate an extremely meaningful measuring result which is not corrupted by ambient air. Two optical sensors are preferably used, of which one optical sensor is arranged in the region of the entry point of the light beam into the measuring cell and thus represents a reference sensor, while the other optical sensor is arranged in the region of the exit point of the light beam from the measuring cell and, combined with the reference sensor, provides the ability to determine the size of the absorption in the optical measuring cell, based on changes of the light beam, and to thereby obtain a statement on a chemical and/or physical property of a fluid in the housing of the measuring cell. The arrangement of the optical sensor(s) without an air gap on an optical element at the entry point or at the exit point of the optical measuring cell has proven to be successful to a particular extent if the humidity or the dew point of a gas in the measuring cell is to be determined, since air gaps in the surroundings have a particularly disturbing effect on the transmission path.

Due to this design of the optical measuring cell including structural units of this type, a maintenance or a repair in the region of the structural units is particularly easy.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of an example of an optical measuring cell according to the invention in an oblique view from above;

FIG. 2 shows a schematic oblique view from above of the optical measuring cell from FIG. 1;

FIG. 3 shows a schematic representation of a cover of the optical measuring cell from FIG. 1;

FIG. 4 shows a schematic representation of a base of the optical measuring cell from FIG. 1;

FIG. 5 shows a schematic representation of the arrangement of roof prisms on the top surface of the cover from FIG. 3; and

FIG. 6 shows a schematic representation of a roof prism including a coupling-in element.

### DETAILED DESCRIPTION

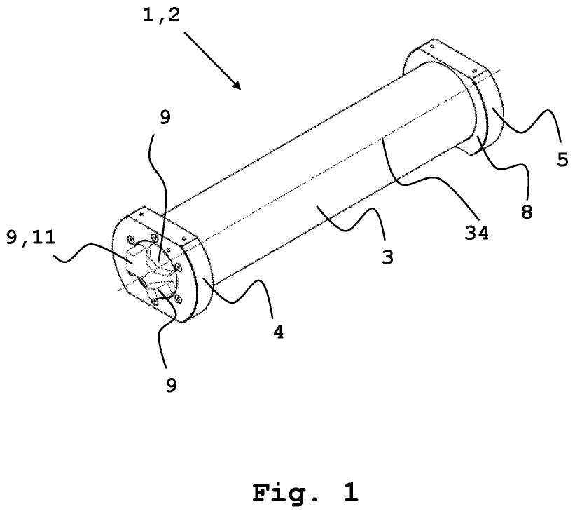

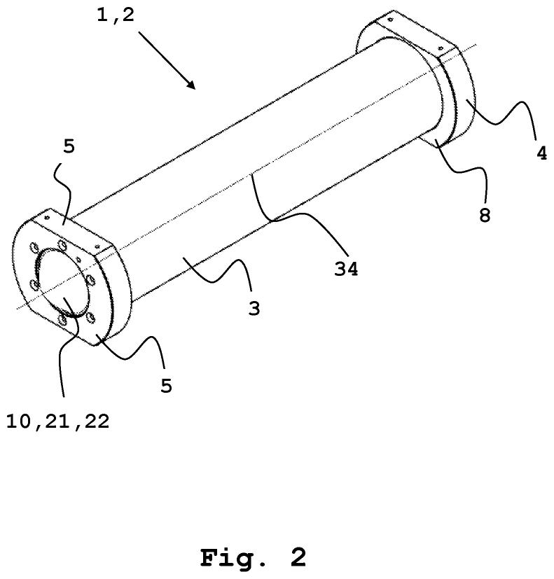

An optical measuring cell 1 for the absorption spectroscopic determination of at least one chemical and/or physical parameter of a fluid is shown in FIG. 1 and FIG. 2, which includes a housing 2 having a tube 3, cover 4, and base 5 made from metal, in particular high-grade steel. Housing 2 is designed as a gas-tight housing 2 and encloses the interior of housing 2 with cover 4, base 5, and tube 3 situated between base 5 and cover 4. The interior is filled with the fluid to be analyzed, in particular the gas to be analyzed.

With the aid of this optical measuring cell 1 according to the invention, it is possible to determine chemical and/or physical parameters of a fluid, for example the concentration of a gas component in a gas mixture, the moisture in an, in particular, gaseous fluid, the temperature and/or also the dew point of the fluid. For this purpose, a laser beam 7 is applied to the fluid-filled interior of optical measuring cell 1, and after passing multiple times, in particular 6 times, through the interior having a length of approximately 60 cm and a diameter of approximately 6 cm, this laser beam 7 is compared with original laser beam 7 with the aid of an optical sensor 41, 42, which is not illustrated in FIGS. 1 and 2, and the chemical and/or physical parameter of the fluid is/are determined therefrom. This is made possible in a very precise and robust way by illustrated optical measuring cell 1, since the construction of optical measuring cell 1 supports this to a special extent with the specially designed beam path in housing 2, by passing through interior 6 of housing 2 multiple times, and thus by the fluid to be analyzed.

Tube 3 is screwed gas-tight to cover 4 at one end and to base 5 at the other end. Cover 4 exhibits a circular region in the extension of interior 6 of tube 3, which is provided with a gas-tight end face 8, on which multiple roof prisms 9 are arranged. Base 5 likewise exhibits a circular region in the extension of interior 6 of tube 3, which is provided with a gas-tight end face 8, which is designed to be gas-tight with the aid of an aspherical lens 21. Aspherical lens 21 is assembled from a spherical lens 10, 22 having a parabolic cross-section, and a plano-convex lens 23, these being fixedly connected by their planar surface by means of gluing. Spherical lens 22 having the parabolic cross-section as part of aspherical lens 21 is apparent in FIG. 2.

The schematic representation of the optical element, which seals the circular region in cover 4 gas-tight is illustrated in a side view in FIG. 3.

A laser beam 7, which is supplied to optical measuring cell 1, for example from a tunable laser as light source 40 for laser beam 7, may be received via a coupling in/out element 11, which is designed as a prism having an orthogonal, triangular cross-section, and deflected in such a way that laser beam 7 is deflected in the direction of interior 6 via a side surface 13 of roof prism 9, after leaving the deflecting element designed as roof prism 9, laser beam 7 having a direction which is oriented in parallel to optical main axis 34 of measuring cell 1 or housing 2 and thus optical measuring cell 1. Coupling-in/out element 11 is fixedly connected to roof prism 9 by gluing and forms a common structural unit which, on the one hand, ensures that no air gap is present between coupling-in/out element 11 and roof prism 9 and, on the other hand, that the structural unit as a whole may be positioned or replaced as needed, thereby ensuring a very secure and maintenance-friendly operation. Coupling-in/out element 11 may furthermore be connected to roof prism 9, and thus also to cover 4, in a fixed and thus statically defined manner.

Laser beam 7 coupled in via coupling-in/out element 11 is deflected in the direction of the focal point of plano-convex lens 23 with the aid of plano-convex lens 23 connected to roof prism 9 by gluing, which forms an end face 8 for sealing the interior of optical measuring cell 1. Plano-convex lens 10 is connected in each case with its planar side to base surfaces of the three roof prisms 9 by gluing in a fixed and optically neutral manner. The connecting surface of roof prisms 9 and plano-convex lens 23 together form end face 8, which seals the circular region of cover 4 gas-tight. Plano-convex lens 23, roof prisms 9, and the adhesive for gluing are preferably selected in such a way that they have the same or nearly the same refractive index.

Coupling-in/out element 11 furthermore has the task of coupling out a laser beam 7, which is supplied via roof prism 9 and enters roof prism 9 having coupling-in/out element 11 after irradiating gas-filled interior 6 of housing 2 multiple times, out of optical measuring cell 1 and thereby makes it possible to compare coupled-out laser beam 7 with original laser beam 7 to be coupled in, using one or multiple optical sensors 41, 42, and thereby makes it possible to determine the desired chemical or physical parameter of the gaseous fluid in interior 6, and thereby allows optical measuring cell 1 to act as part of an optical measuring arrangement according to the absorption spectroscopic method.

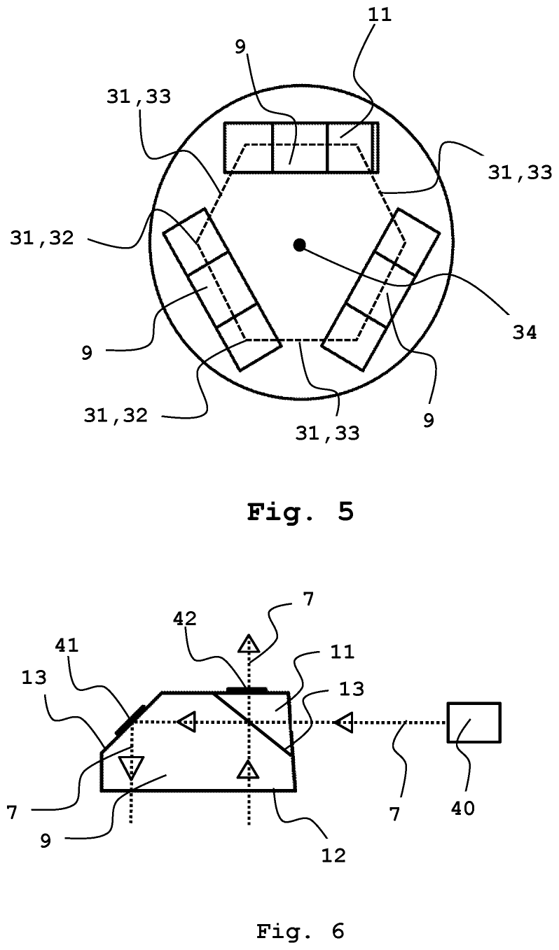

As schematically illustrated in FIG. 5 in connection with FIG. 6, the three roof prisms 9 shown in FIG. 3 are arranged above three sides 33 of a regular hexagon 31, a not completely covered, empty side 33 being present between each of roof prisms 9. End face 8 illustrated in FIG. 5 corresponds to the planar surface of plano-convex lens 23, which is connected to base surfaces 12 of roof prisms 9. Roof prisms 9 are selected in such a way that side surfaces 13 of roof prisms 9 are situated above vertex points 32 of regular hexagon 31 and thereby ensure that a laser beam 7 incident upon the region of a vertex 32 from the direction of interior 6 in parallel to optical main axis 34 is deflected by side surfaces 13 in such a way that laser beam 7 continues to run in roof prism 9 in parallel to base surface 12 and leaves roof prism 9 in the direction of interior 6 on the other side surface 13 of roof prism 9 in the direction of other vertex 32, over which latter side surface 13 is arranged, and thus in parallel to optical main axis 34 and offset with respect to incident laser beam 7. This roof prism 9 thus forms a deflecting element according to the invention.

Due to the arrangement of the three roof prisms 9 on the three non-adjacent sides 33 of regular hexagon 31, a rotationally symmetrical design of cover 4, including the deflecting elements designed as biprisms 9 arranged thereon, is given. The rotation point of the rotationally symmetrical design forms center point 35 of hexagon 31 and simultaneously the point at which optical main axis 34 penetrates end face 8.

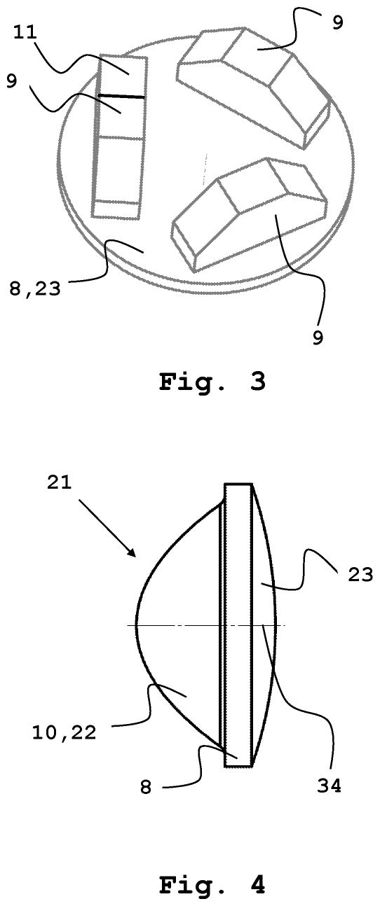

FIG. 4 shows a side view of a biconvex, aspherical lens 21, which is made up of a plano-convex lens 23 and a spherical lens 22 having a parabolic cross-section, these lenses 22, 23 being fixedly connected to each other with their planar surfaces by gluing. Lenses 22, 23 and the adhesive are selected in such a way that their refractive index is the same or largely the same. End face 8, which seals the interior of optical measuring cell 1 gas-tight and in which the laser beams oriented in the direction of the interior or out of the interior run in parallel to optical main axis 34, is situated in the connecting region between plano-convex lens 23 and spherical lens 22.

Alternatively, it has proven to be successful to form biconvex, aspherical lens 21 as a single piece with a plano-convex lens part 23 and a spherical lens part 22 having a parabolic cross-section.

Spherical lens 22 having a parabolic cross-section is designed in such a way that it forms a deflecting element and thereby reflects an incident laser beam 7 running in parallel to optical main axis 34 of housing 2 laterally offset n the direction of interior 6 of housing 2 in parallel to optical main axis 34. Plano-convex lens 23 is connected with the aid of its planar side to the planar surface of spherical lens 22. This connecting surface forms end face 8, which seals the circular region of base 5 gas-tight.

Plano-convex lens 23 of base 5 and plano-convex lens 10 of cover 4 exhibit the same focal length f and are arranged in tube 3 in the particular end region in such a way that their distance from each other corresponds to twice the focal length f, and they have a common focal point in the center of tube 3.

This makes it possible for laser beams 7 running in parallel to optical main axis 34 from the deflecting elements to enter the two plano-convex lenses 10, 23 via the planar surfaces thereof and to be deflected thereby in the direction of the common focal point and enter the convex surface of opposite plano-convex lens 23, 10 and be reflected by this lens in parallel to laser beams 7 running in parallel to optical main axis 34, which enter, via the particular planar surfaces of plano-convex lenses 23, 10, assigned spherical lens 22 having a parabolic cross-section or roof prisms 9 and be laterally offset thereby and be reflected in the direction of interior 6 in parallel to optical main axis 34 to subsequently be focused again in the direction of common focal points 24 by connected, plano-convex lenses 23, 10.

A lateral offset along one side 33 or by the length of one side 33 of hexagon 31 is effectuated by the positioning and arrangement of roof prisms 9. Spherical lens 22 is designed in such a way that such an offset of reflected laser beam 7 takes place thereby, which runs axisymmetrically to optical main axis 34 of measuring cell 1 or housing 2 and thus optical measuring cell 1. A side change and thus a reflection of incident laser light 7 on the opposite side of the point of incidence is achieved thereby. The offset between the deflecting element of cover 4 having roof prism 9 and the offset of the deflecting element in base 5 having spherical lens 22 are fundamentally different from each other. The one offset takes place along the side lines of regular hexagon 31 arranged around the optical center line, while the other offset effectuates a lateral change with respect to optical center line 34. A multiple irradiation of interior 6 over common focal point 24 is effectuated by these differences in the offset between base 5 and cover 4, the coupling-in and coupling-out points of the deflecting elements changing regularly in roof prisms 9 or in spherical lens 22.

In optical measuring cell 1 illustrated in the figures, laser beam 7 is coupled in via a common coupling-in/out element 11, which is arranged on a side surface 13 of a roof prism 9, and, after the passage through all three roof prisms 9 and assigned vertices 32 with opposite base 5 and the particular oblique crossing of interior 6 of housing 2, it is again coupled-out of optical measuring cell 1.

Roof prism 9 having coupling-in/out element 11 is provided with two optical sensors 41, 42. Optical sensor 41 is arranged over a wide area without an air gap on side surface 13 of roof prism 9 for the purpose of measuring the optical properties there, in particular the intensity of incident laser light 7 from laser light source 40 during the first deflection in the direction of the interior of optical measuring cell 1 and thus in the coupling-in region. The other optical sensor 42 is arranged in the coupling-out region of laser light 7, in that it is arranged on the side surface of coupling-in/out element 11 in such a way that laser light 7 is measured during the coupling-out from measuring cell 1 with respect to the optical properties, in particular the intensity of laser light 7, after the multiple passage through the interior of measuring cell 1. The desired chemical or physical property of the fluid to be analyzed in the interior of measuring cell 1 may be determined by comparing the measured values of the two optical sensors 41, 42.

Due to this multiple passage through the interior having the gas to be analyzed, it is possible to make a very precise statement on the absorption properties of the gas and thus the chemical or physical parameters of the gas, for example the moisture content of a compressed air. This is especially applicable, since a highly robust and not very sensitive determination is made possible by this arrangement. It has been shown that this arrangement has also been proven to have little susceptibility to contaminants, in particular due to the introduced gas to be analyzed, which is achieved, in particular, by the use of plano-convex lenses 10, 23. By designing the inner wall of tube 3 as a blackened inner wall and thus as a non-reflective surface, it is also possible to minimize the influences of stray light, which is coupled into the optical path of laser beam 7 and corrupts the measurement result, and thereby further increase the achievable precision of optical measuring cell 1.

By designing this optical measuring cell 1 with screwed-on gas-tight cover 4 and screwed-on gas-tight base 5 and with tube 3 without optical elements, it is furthermore possible to particularly easily maintain and inspect optical measuring cell 1 or its housing 2. The quality of optical measuring cell 1 and thus the entire optical measuring arrangement may be kept particularly high thereby.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An optical measuring cell for absorption spectroscopic determination of at least one chemical and/or physical parameter of a fluid, the optical measuring cell comprising:
a housing having a tube, cover, and base;
a coupling-in element connected to the housing, the coupling-in element couples a light beam into an interior of the housing such that the coupled-in light beam runs substantially in parallel to an optical main axis;
deflecting elements connected to the cover and the base, the deflecting elements reflecting an incident light beam running substantially in parallel to the optical main axis laterally offset into the interior of the housing substantially in parallel to the optical main axis;
a coupling-out element connected to the housing, the coupling-out element coupling out a striking light beam,
wherein a fluid-filled interior of the housing is irradiated multiple times, and
wherein n (n>1) deflecting elements designed as roof prisms are connected to the cover and/or to the base such that they are arranged on each second side of a regular 2n-gon.

2. The optical measuring cell according to claim 1, wherein the cover is connected to the n deflecting elements designed as roof prisms such that they are arranged on each second side of a regular 2n-gon, n=3 being selected, in particular, and wherein the base is connected to a deflecting element designed as a concave mirror or plano-convex lens, in particular having a parabolic cross-section.

3. The optical measuring cell according to claim 1, wherein the deflecting elements connected to the cover and the base are selected from roof prisms, plano-convex lenses, concave mirrors, conical mirrors, conical lenses, or retro-reflector optical units.

4. The optical measuring cell according to claim 1, wherein at least one deflecting element is designed such that the incident light beam and the reflected light beam run axisymmetrically to the optical main axis.

5. The optical measuring cell according to claim 1, wherein the coupling-in element and/or the coupling-out element is/are connected to the cover or the base.

6. The optical measuring cell according to claim 1, wherein the coupling-in element and/or the coupling-out element has/have an optical element, in particular a prism, connected to a roof prism.

7. The optical measuring cell according to claim 1, wherein the arrangement of the housing, including the tube, cover, and base as well as the deflecting elements, is designed to be rotationally symmetrical to the optical main axis.

8. The optical measuring cell according to claim 1, wherein a plano-convex lens is assigned to the cover and the base, which is connected to the deflecting elements, in particular by its planar side.

9. The optical measuring cell according to claim 8, wherein at least one plano-convex lens is connected by its planar side to at least one deflecting element via gluing.

10. The optical measuring cell according to claim 9, wherein the two plano-convex lenses exhibit a focal length, which is equal to half the length of the working distance between the two plano-convex lenses.

11. The optical measuring cell according to claim 1, wherein the surface of the tube facing the interior is at least partially designed as a light-absorbing and/or non-reflective surface.

12. The optical measuring cell according to claim 1, wherein the housing is designed to be gas- and/or pressure-tight and for a gaseous fluid as the substance to be measured.

13. The optical measuring cell according to claim 1, wherein a semiconductor light source, in particular a laser or an LED light source for generating the light beam, is assigned to the optical measuring cell.

14. The optical measuring cell according to claim 1, wherein at least one sensor assigned to the optical measuring cell, including a deflecting element, the coupling-in element, or the coupling-out element is designed as a single structural unit, and/or a light source assigned to the optical measuring cell, including the coupling-in element, are designed as individual structural units or jointly as a single common structural unit.
